(19) United States
(12) Patent Application Publication
(10) Pub. No.: US 2002/0089598 A1
(43) Pub. Date: Jul. 11, 2002

(54) Driving method for solid state imaging device

(75) Inventors: Kazuo Ishimoto, Anpachi-gun (JP); Tohru Watanabe, Ogaki-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/041,144

(22) Filed: Jan. 4, 2002

(30) Foreign Application Priority Data
Jan. 9, 2001 (JP) 2001-1242

(51) Int. Cl. H04N 5/335

(52) U.S. Cl. 348/311; 348/312; 348/296

(57) ABSTRACT

To improve the dynamic range of an output signal from a CCD image sensor, an exposure time, beginning with the completion of an electronic shutter operation started in response to an STTRG pulse (22) and lasting until the beginning of a frame shift operation, is divided into two parts according to a WTTRG pulse 26. Information charges accumulated in an odd line during a preceding first exposure time A are vertically transferred to an adjacent even line at a timing defined by the WTTRG pulse 26, and the information charges for both lines are compounded there. Another exposure is applied to the odd and even lines during a second exposure time B, and information charges generated in the odd and even lines are vertically transferred into a horizontal CCD shift register for compounding. The thus-compounded charges are output from a CCD image sensor through horizontal transfer.

### BACKGROUND OF THE INVENTION

1. Field of the Invention

The present invention relates to a driving method for a solid state imaging device, and in particular to improvement of a dynamic range of a charge coupled device (CCD) image sensor.

2. Description of the Related Art

A variety of CCD image sensor types are available, with each type having a different structure for transferring an information charge generated in a photodiode to an output section. Specific examples of these include a frame transfer type and an interline transfer type, as well as a frame-interline transfer type, which includes characteristics of both of the first two types. Common to all of these types is that a photodiode generates an information charge according to the amount of incident light, that a vertical CCD shift register vertically transfer the information charge to a horizontal CCD shift register, and that the horizontal CCD shifter register horizontally transfers the information charge to an output section.

In order to reduce the size and increase the resolution of cameras, attempts have been made to reduce the imaging area of a CCD image sensor and to increase the number of pixels. Accompanying such attempts, the size of a photodiode and that of a vertical shift register are accordingly reduced, with the result that the amount of charges that these members can handle is limited. However, unless all information charges generated in a photodiode can be transferred to an output section, any attempt to improve sensitivity through enlargement of a photodiode may be doomed to failure.

In consideration of the above, interline or frame-interline type CCD image sensors are basically designed such that the vertical shift register has a charge handling capacity greater than the maximum amount of charges that can be accumulated in the photodiode. Moreover, for frame transfer type CCD image sensors, the vertical shift register in a storage section is basically designed so as to have a charge handling capacity greater than the maximum amount of charges that can be handled by the vertical shift register in an imaging section, which serves also as a light receiving pixel, and the horizontal shift register is designed so as to have a charge handling capacity greater than the maximum amount of charges that can be handled by the vertical shift registers. It should be noted that it is relatively easy to increase the charge handling capacity of the horizontal shift register by forming, independent of the size of the imaging area, a wider channel width.

In conventional CCD image sensors, an image formed by an optical system is projected on an imaging section, at which an appropriate exposure time is set through operation of an electronic shutter or using a mechanical shutter or the like, according to the brightness of the image. Specifically, the level of a signal output from a CCD image sensor is measured, and a charge accumulating time of the CCD image sensor is adjusted to bring the level to an appropriate value. According to this type of conventional exposure time control, the time for the imaging section to accumulate information charges is set to a uniform value for every pixel. At the end of the accumulating time, according to the transfer method described above, information charges aligned in the vertical shift register are sequentially transferred to the horizontal shift register, which in turn transfers the information charges received for one line from the vertical shift registers, to the output section.

Under the above described exposure time control, the dynamic range of an imaging signal of an imaging device using a CCD image sensor is limited by the maximum charge capacity of the CCD image sensor. The maximum charge capacity of a CCD image sensor is in turn limited, for a frame transfer type, by the amount of charge that a vertical shift register in the imaging section, which serves also as a photodiode, can handle, and, for an interline transfer or frame interline transfer type, by the maximum amount of charge that the photodiode can accumulate (the maximum charge storage capacity), as described above. Therefore, in order to improve the dynamic range of an imaging signal, the maximum charge capacity of these sections (the maximum charge handling capacity) must be increased. However, increasing the maximum charge handling capacity of these devices while simultaneously increasing the pixel density thereof is not readily achievable. There is therefore a problem that improvement of a dynamic range is limited.

### SUMMARY OF THE INVENTION

The present invention has been conceived in order to overcome the above problems and aims to provide a method for driving a CCD image sensor manufactured using a conventional method, so as to improve the dynamic range of an output signal thereof.

According to a first aspect of the present invention, there is provided method for driving a solid state imaging device including a plurality of vertical shift registers each for vertically transferring information charges accumulated in a plurality of light receiving pixels arranged in matrix, and a horizontal shift register for horizontally transferring information charges vertically transferred and received in line units, in which, the information charges are independently vertically transferred from light receiving pixels in an odd line and from light receiving pixels in an even line.

This method comprises an accumulation step of accumulating the information charges generated in the plurality of light receiving pixels during a first period in portions of vertical shift registers corresponding to each odd line and in portions of vertical shift registers corresponding to each even line; a first compounding step of vertically transferring the information charges accumulated in the portions of vertical shift registers corresponding to each odd line to the portions of vertical shift registers corresponding to each adjacent even line, of compounding the information charges originated from the portions of vertical shift registers corresponding to each odd line into the information charges accumulated in the portions of vertical shift registers corresponding to each adjacent even line, and of holding resultant information charges in the portions of vertical shift registers corresponding to each even line; an additional accumulation step of accumulating information charges generated in a light receiving pixel in each odd line during a second period in the portions of vertical shift registers corresponding to each odd line, and of accumulating information charges generated in a light receiving pixel in each even line during the second period in the portions of vertical shift registers corresponding to each even line in addition to the information charges that are already accumulated therein; a second compounding step of transferring the information charges accumulated in the portions of vertical shift registers corresponding to each odd line and the information charges accumulated in the portions of vertical shift registers corresponding to each even line to the horizontal shift register, and of compounding in the horizontal shift register the information charges originated from the portions of vertical shift registers corresponding to each odd line into the information charges originated from the portions of vertical shift registers corresponding to each even line; and a step of driving the horizontal shift register after the second compounding step to obtain an information output of the solid state imaging device.

According to this aspect of the present invention, at the accumulation step, each of the light receiving pixels generates information charges during a common first period. With a frame transfer type solid state imaging device, the generated information charges are accumulated in the plurality of vertical shift registers in the imaging section. That is, information charges generated in odd and even lines are accumulated in portions of the vertical shift registers corresponding to the respective lines without requiring any special operation. On the other hand, with an interline transfer type solid state imaging device, generated information charges are tentatively accumulated in photodiodes. Then, information charges in each photodiode are read and supplied to a corresponding bit in a vertical shift register, whereby information charges generated in each line are accumulated in the corresponding portions of the vertical shift registers corresponding to that line.

At the first compounding step, information charges in just an odd line are shifted to an adjacent even line, while information charges in the even line remain where they are, such that information charges in the odd line are brought to the even line and compounded into the information charges therein. Basically, the amount of compounded information charges accumulated in an even line can be expected to be proportional to the total amount of incident light relative to the pixels in the concerned odd and even lines. However, in some cases, the amount of compounded information charges resulted at the first compounding step may not retain such linearity relative to the incident light amount. That is, the amount of information charges generated corresponding to a higher luminance portion of an object may be subjected to the upper limitation due to the maximum storable amount of information charges of the pixel and resultantly reaches a saturation point of the pixel. Immediately after the first compounding step, the amount of information charges in each odd line is zero, from which state the additional accumulation step begins.

Also at the additional accumulation step, odd and even lines generate information charges during a common second exposure period. For a solid state imaging device of a frame transfer type, generated information charges are accumulated in the plurality of vertical shift registers in the imaging section. That is, the additional accumulation step can be executed without requiring a special operation. For a solid state imaging device of one of the other two types described above, on the other hand, information charges are read from a photodiode and supplied to a vertical shift register, whereby the additional accumulation step is executed. The information charges accumulated in each even line are those that have undergone information charge compounding at the first compounding step and also the additional accumulation step, and which thus are equivalent to those that would have been generated through exposure for a period substantially twice the first period and the second period. Therefore, a lager amount of information charges are likely to be accumulated in an even line, and an even line is likely to be saturated with information charges. On the other hand, the amount of information charges accumulated in an odd line is not as large as in an even line, and the odd line is therefore less likely to be saturated with information charges.

At the second compounding step, information charges for adjacent even and odd lines are compounded in the horizontal shift register, which is thereafter driven so that a signal output of the solid state imaging device is obtained. The output signal thus obtained presents such a nature, as a result of the information charge compounding, that a large charge amount is generated with respect to a lower luminous portion of an object, while, for a higher luminous portion of the object, the output signal contains luminous difference information. This is achieved through addition to the output signal through the compounding in the horizontal shift register of luminance information originated from an odd line, which is unlikely to be saturated with information charges for higher luminance. Under identical conditions, an even line is more likely to be saturated.

As described above, the dynamic range of an imaging signal is expanded. It should be noted that the maximum charge handling capacity of the horizontal shift register and the length of the second exposure time are determined such that the compounding at the second compounding step does not cause the horizontal shift register to be saturated.

According to a second aspect of the present invention, there is provided a method for driving a solid state imaging device including a plurality of vertical shift registers each for vertically transferring information charges accumulated in a plurality of light receiving pixels arranged in matrix, and a horizontal shift register for horizontally transferring the information charges vertically transferred and received in line units, in which the information charges are independently vertically transferred from light receiving pixels in an odd line and from light receiving pixels in an even line.

This method comprises an imaging step of accumulating, only during a first period, the information charges generated in the light receiving pixels in each odd line and of accumulating during a second period the information charges generated in the light receiving pixels in each even line, the second period being shorter than the first period, and a compounding step of vertically transferring the information charges accumulated in the light receiving pixels in each odd line and the information charges accumulated in the light receiving pixels in each even line to the horizontal shift register after the imaging step, and of compounding the information charges originated from the light receiving pixels in each odd line with the information charges originated from the light receiving pixels in each even line.

According to the present invention, light receiving pixels in an even line are exposed for a shorter time than those in an odd line. This is achieved by constructing, for example, an interline transfer type solid state imaging device so as to allow independent control of information charge transfer to a vertical shift register from a photodiode in each odd line and in each even line so that only information charges in each odd line can be read and discharged midway through an exposure. Specifically, exposure to all photodiodes in respective lines is begun at the same time and, at subsequent set timing, only information charges accumulated in each even line are read into vertical shift registers, which are then driven so as to discharge the information charges therein. Thereafter, exposure to the photodiodes in each even line is resumed, and, at the end of the exposure, information charges are read from the photodiodes in even and odd lines simultaneously, and supplied to the vertical shift registers.

For a frame transfer type of a solid state imaging device, an exposure time for an even line is made shorter than that for an odd line by driving such that a potential well is not formed in portions of vertical shift registers corresponding to each even line for a certain period. With this arrangement, the information charges generated in an odd line are exposed longer than are those in an even line. Therefore, the thus generated information charges in an odd line may exhibit such a nature that a large amount of information charges are likely to be accumulated with respect to a lower luminous portion of an object, and that they are likely to accumulate to an amount corresponding to a saturation point. On the other hand, for an even line, an amount of information charges as large as those for an odd line are unlikely to accumulate, and these information charges are therefore unlikely to accumulate to an amount corresponding to a saturation point.

At the compounding step, information charges having different characteristics originating from even and odd lines are transferred to the horizontal shift register for compounding. The horizontal shift register is then driven to generate a signal output from the solid state imaging device.

The output signal thus obtained exhibits such a nature, as a result of the information charge compounding, that a large charge amount is likely to be generated with respect to a lower luminous portion of an object. As for a higher luminous portion of an object, the output signal contains luminous difference information, as a result of the addition thereto of luminance information originated from an even line through the compounding in the horizontal shift register, wherein the even line is unlikely to be saturated with information charges for higher luminance, while an odd line is likely to be saturated under identical conditions.

### BRIEF DESCRIPTION OF THE DRAWINGS

The above and other objects, features, and advantages of the present invention will become further apparent from the following description of the preferred embodiment taken in conjunction with the accompanying drawings wherein:

FIG. 1 is a schematic block diagram showing an imaging apparatus according to the present invention;

FIG. 2 is a flowchart explaining operation of an imaging apparatus according to a first embodiment of the present invention;

FIG. 3 is a schematic timing diagram relating to driving pulses and output signals, for explaining operation of the imaging device according to the first embodiment of the present invention;

FIG. 4 is a schematic graph showing relationship between an information charge amount Q and an incident light amount I in the case of Q_{HMAX}<Q_{VMAX} with the first embodiment;

FIG. 5 is a schematic graph showing relationship between an information charge amount Q and an incident light amount I in the case of Q_{HMAX}<Q_{VMAX} with the first embodiment; and

FIG. 6 is a schematic graph showing relationship between an information charge amount Q and an incident light amount I with the first embodiment.

### DESCRIPTION OF THE PREFERRED EMBODIMENTS

Preferred embodiments of the present invention will be described with reference to the drawings.

Embodiment 1

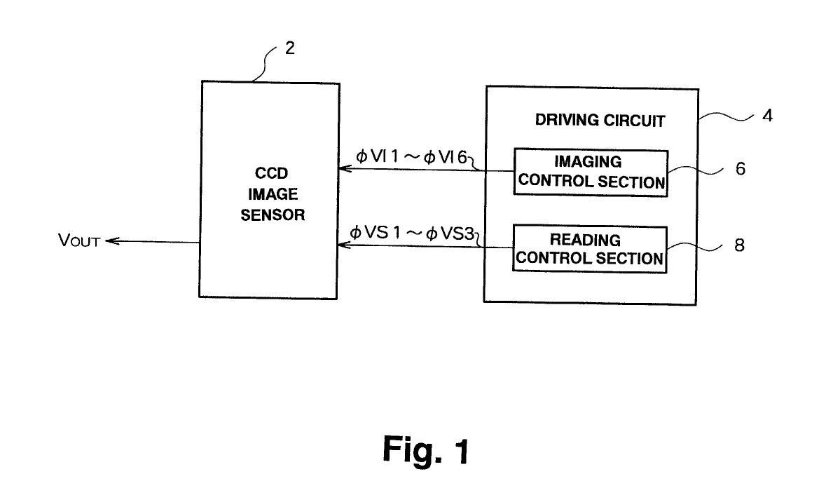

FIG. 1 is a schematic block diagram showing an imaging apparatus according to the present invention. This apparatus comprises a CCD image sensor 2 of a frame transfer type and a driving circuit 4 for driving the CCD image sensor 2. The driving circuit 4 comprises an imaging control section 6 for controlling operation of an imaging section in the CCD image sensor 2, and a reading control section 8 for controlling operations of a storage section and a horizontal CCD shift register both also in the CCD image section 2.

The imaging section and the storage section each comprise a plurality of vertical CCD shift registers aligned in parallel, and manipulate the potential within the substrate, using an electrode formed on the substrate, to control charge accumulation and transferring. The imaging section receives voltage clock signals of six phases φ_{VI1} to φ_{VI6}, three out of them being applied to each line of the imaging section. Specifically, clock signals φ_{VI1} to φ_{VI3} may be applied to each odd line, while clock signals φ_{VI4} to φ_{VI6} may be applied to each even line. As three phases are applied, different information charge packets can be accumulated in odd and even lines in the imaging section. Moreover, as the odd and even lines can be independently driven in three phases, they can operate independently. This enables operation such that, for example, charge packets accumulated in an odd line are vertically transferred to an adjacent even line, while charge packets accumulated in the even line are held there such that the information charges are compounded.

The storage section, which is entirely covered by a light shielding film so as to prevent charge generation due to light incident thereto, can retain image information that has been frame-shifted thereto from the image section. The respective lines of the storage section are supplied with voltage clock signals of three phases φ_{VS1} to φ_{VS3} to be thereby commonly driven. With application of three phases to each line, different information charge packets can be accumulated in odd and even lines in the storage section, similarly to the imaging section. Moreover, as odd and even lines are driven in response to a common three-phase clock, information charges accumulated in odd and even lines in the storage section can be vertically transferred simultaneously in parallel.

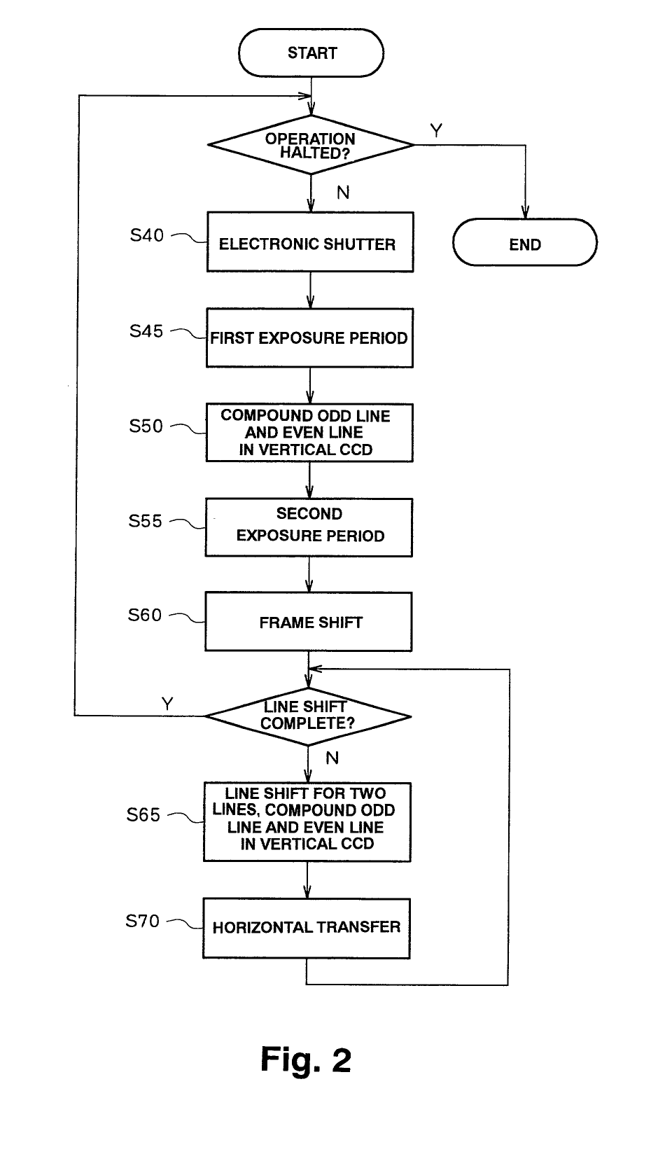

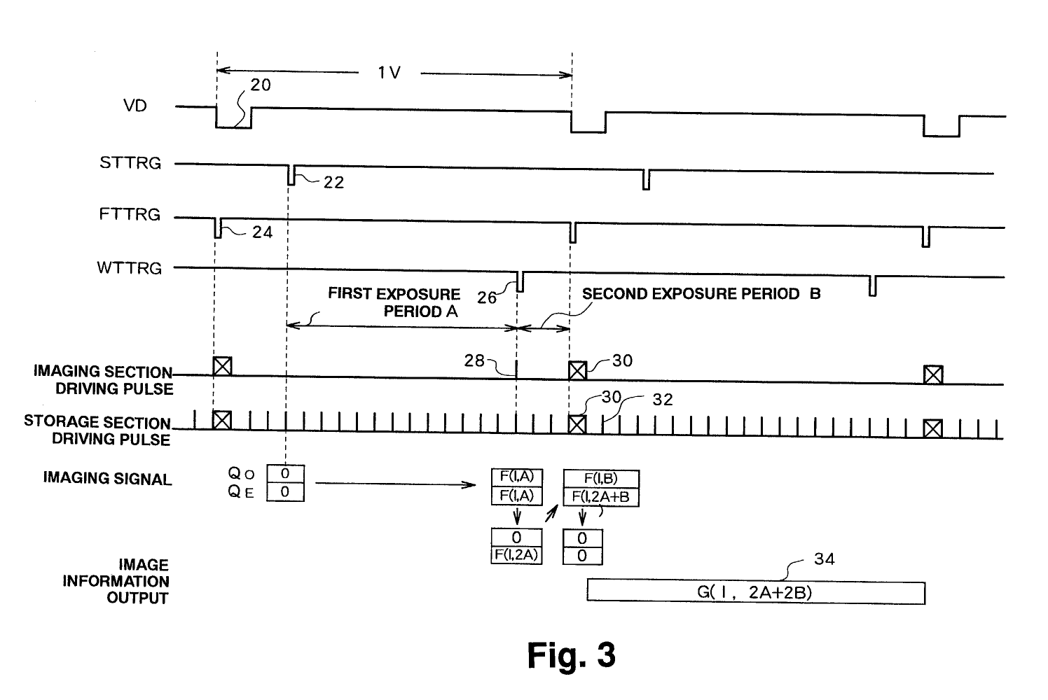

FIG. 2 is a flowchart explaining operation of the present invention. FIG. 3 is a schematic timing chart concerning driving pulses and output signals for explaining operation of the present invention.

Referring to FIG. 3, a signal VD is a vertical synchronous signal, and a period with a low (L) VD corresponds to a vertical blanking period with one cycle thereof corresponding to one field A signal STTRG is a signal for supplying a shutter trigger pulse (STTRG pulse) 22, which defines timing for an electronic shutter operation.

A signal FTTRG is a signal for supplying a frame shift trigger pulse (FTTRG pulse) 24, which defines timing for frame shifting. Because frame shifting is caused during a vertical blanking period, an FTTRG pulse 24 is also caused during a vertical blanking period.

A signal WTTRG is a signal for supplying a trigger pulse (WTTRG pulse) 26 for use in control of an exposure time. A trigger pulse 26 specifically defines timing at which to switch from a first exposure time to a second exposure time, as described below.

An imaging section driving pulse is the above-mentioned voltage clock signals φ_{VI1} to φ_{VI6}, while a storage section driving pulse is the above-mentioned voltage clock signals φ_{VS1} to φ_{VS3}.

The imaging signals shown in FIG. 3 schematically represent the amount of information charges Q₀, Q_{E} accumulated in an odd line (the (2i−1)^{th} line) and in the next even line (the 2i^{th} line), respectively. A picture information output is an output signal V_{OUT} from the CCD image sensor 2.

With this apparatus, two exposures are performed during one frame period. The beginning of the first exposure time A is defined by an electronic shutter operation (S40). In an electronic shutter operation, which is activated by an STTRG pulse 22, a positive voltage pulse is applied to the back surface of the substrate, for example, and information charges having been accumulated in the imaging section thus far, or by the midpoint of the frame period, are extracted to the back surface of the substrate, and then discharged. Upon completion of this electronic shutter operation, processing of charge accumulation in the imaging section is freshly initiated, this point constituting the timing at which the first exposure time A is started(S45).

During the exposure, information charges may be generated in each pixel in odd and even lines in the imaging section according to the luminance of a corresponding part of an object and the duration of the first exposure time. In other words, the amount of information charges Q generated and accumulated in each pixel can be expressed as a function F (I, T) of the amount of incident light I to that pixel and the exposure time T.

After the lapse of the first exposure time A, a WTTRG pulse 26 is generated. Triggered by this pulse 26, the imaging control section 6 generates imaging section driving pulses φ_{VI1} to _{VI6} (a pulse group 28), and, in response to those pulses, information charges Q_{O} accumulated in an odd line (the (2i−1)^{th} line) in the imaging section are vertically transferred to an adjacent even line (the 2i^{th} line) (S50). The first exposure time A covers a period from the execution of an electronic shutter operation to this vertical transfer operation. Because even lines are not driven during this vertical transfer operation, no charge will shift from even lines (the 2i^{th} lines) to adjacent odd lines (the (2i+1)^{th} lines). Therefore, as a result of this vertical transfer operation, the information charge accumulated in the odd line (the (2i−1)^{th} line) is brought to the even line (the 2i^{th} line) to be compounded into the information charge therein.

FIG. 3 shows that information charge amounts Q_{O}, Q_{E} are both zero at the beginning of the first exposure time, and F (I, A) at the end of the period. For brevity of explanation, in the following description any difference in the amount of light incident to an odd line (the (2i−1)th line) and in an adjacent even line (the 2i^{th} line) is disregarded. FIG. 3 also shows that, as a result of the compounding of information charges originated from odd and even lines due to the vertical transfer operation, the information charge amount Q_{O} has become zero, and that the information charge amount Q_{E} has become F (I, 2A), which is equivalent to the amount that would be accumulated during an exposure twice as long as the first exposure time. It should be noted that it is often expected that F (I, 2A) should be equal to the sum of the information charge amounts Q_{O} and Q_{E} before the compounding, that is, F(I, 2A)=F(I, A)+F(I, A). This, however, is not always true. That is, in the case where the sum of the information charge amounts Q_{O} and Q_{E} before the compounding should exceed the maximum amount of charges that a single pixel of a vertical CCD shift register can accumulate, or Q_{VMAX}, in the imaging section, the pixel in an even line that is expected to accumulate the resultant compounded information charges would be saturated with information charges, resulting in F (I, 2A)=Q_{VMAX}.

Upon completion of the process of transferring the information charges generated during the first exposure time to an even line for compounding, a second exposure time B begins (S55). During this exposure, an information charge is generated in each pixel in odd and even lines in the imaging section according to the luminance of a corresponding part of an object and the duration of the second exposure time. The end of the second exposure time B is defined by timing at which to start a frame shift operation. In a frame shift operation, which is triggered by an FTTRG pulse 24, the imaging control section 6 and the reading control section 8 supply frame shift pulse groups 30 to the imaging section and the storage section, respectively, and, in response to those pulses, information charges are vertically transferred from the imaging section to the storage section at a high speed (S60).

FIG. 3 shows that information charge amounts Q_{O} and Q_{E} are F (I, B) and F (I, 2A+B), respectively, at the end of the second exposure. Here again, should saturation occur, as is described in connection with the compounding following the vertical transfer, F (I, 2A+B) is limited up to Q_{VMAX}, rather than F (I, 2A)+F(I, B). Therefore, F(I, 2A+B)=F(I, 2A)+F(I, B) does not hold. FIG. 3 also shows that, as a result of frame shifting, the information charge amounts Q_{O}, Q_{E} have both become zero.

The information charges that were frame-shifted to the storage section are then vertically transferred in a line-shift operation with a cycle of one horizontal scanning period. The line shift operation is activated in response to signals φ_{VS1} to φ_{VS3}, which are generated in the reading control section 32. A line shift operation for each horizontal scanning period involves an operation of vertically transferring information charges in each even line (the 2i^{th} lines) to the horizontal CCD shift register, and of vertically shifting information charges in each odd line (the (2i−1)th lines) to the horizontal CCD shift register. That is, a line shift pulse group 32 constitutes clocks for transferring information charges for two adjacent odd and even lines to the horizontal CCD shift register. As the operation of the horizontal CCD shift register is halted while the information charges are read from the two lines and vertically transferred to the horizontal CCD shift register, information charges originated from the odd (the (2i−1)th line) and even (the 2i^{th} line) lines are compounded (S65). The amount of information charges Q that have been accumulated in the horizontal CCD shift register as a result of the compounding is expressed as a function G (I, T) concerning the amount of incident light I to a corresponding pixel and the total exposure time T concerning the two lines. Because the maximum information charge handling capacity of the horizontal CCD shift register can be set larger than that can be handled by the vertical CCD shift registers, the horizontal CCD shift register is constructed such that it will not be saturated with information charges as a result of compounding of the information charges for two lines. Therefore, with this arrangement, the amount of information charges resulting from this compounding will satisfy the relationship G (I, 2A+2B)=F (I, 2A+B)+F(I, B).

After information charges originated from two lines are compounded to thereby generate information charges for one line in the horizontal CCD shift register, the horizontal CCD shift register is driven so that horizontal transfer is conducted (S70), so that an output signal V_{OUT} from the CCD image sensor 2 (signal 34) is in turn generated.

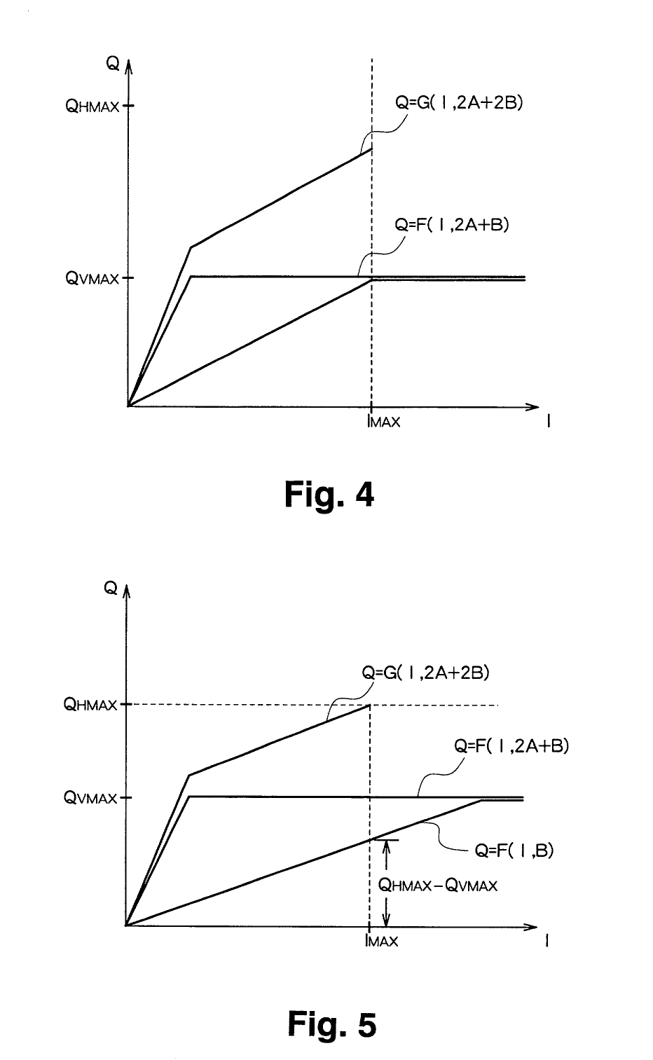

FIG. 4 is a diagram schematically showing the relationship between the amount of information charges Q generated according to the present driving method and an incident light amount I. The function F (I, 2A+B) concerning the amount of information charges generated in an even line (the 2i^{th} line) at the end of the second exposure time has a large value even in the range of a small amount of incident light I, and is likely to reach a saturation point from a relatively small amount of incident light amount I. The function F (I, B) concerning the amount of information charges generated in an odd line (the (2i−1)^{th} line), on the other hand, does not reach such a large value, and is unlikely to reach a saturation point. Because the function G (I, 2A+2B) concerning the amount of information charges obtained by compounding these information charges having different characteristics in the horizontal CCD shift register does not form a plateau in the range of a small amount of incident light I, where the function F (I, 2A+B) has reached a saturation point, the range of incident light amount wherein the amount of information charges to be generated may vary depending on the amount of incident light is expanded. That is, the dynamic range of an output signal V_{OUT} from the CCD image sensor 2 is widened and improved.

The gradient of the function G differs between an incident light amount range where the function F (I, 2A+B) has reached a saturation point and a range where the function F (I, 2A+B) has not reached a saturation point. That is, linearity is not ensured throughout the entire range of incident light amounts. An output signal V_{OUT} from the CCD image sensor 2, however, is originally subjected to no-linear conversion in a γ correction. Therefore, non-linearity of the signal V_{OUT} does not result in any particular problems. Because such non-linearity can be anticipated, γ correction may be made with consideration of such non-linearity.

In the following, a method for setting a second exposure time will be described.

The function F (I, T) will vary with a gradient according to the exposure time T until it reaches a saturation point, specifically, with a gradient basically proportional to the exposure time T. That is, with an excessively steep gradient, the function F (I, B) may reach a saturation point even for the amount of incident light smaller than that from the maximum luminous portion of an image, i.e., I_{MAX}. This is not preferable as it may create a plateau to the function G. Basically, the second exposure time is determined such that the function F (I, B) does not reach the maximum charge handling capacity of the vertical CCD shift register Q_{VMAX} for the amount of incident light smaller than the maximum amount of incident light I_{MAX} from an object.

Meanwhile, the function G lends itself to the steepest possible gradient, or gain. The gradient of the function G within the range of an incident light amount where the function F (I, 2A+B) has reached a saturation point is equal to that of the function F (I, B). Therefore, the steepest possible gradient, which requires a longer second exposure time B, is preferable for the function F (I, B). In the present apparatus, based on the estimated maximum amount of incident light I_{MAX} from an object, a value B that achieves F (I_{MAX}, B)=Q_{VMAX} is set as the second exposure time B.

In the above described structure, the maximum charge handling capacity of the horizontal CCD shift register Q_{HMAX} is designed to have a maximum charge handling capacity twice or more that of the vertical CCD shift register Q_{VMAX} so that the horizontal CCD shift register is prevented from being saturated as a result of the compounding of information charges for two lines. The second exposure time described above is also determined based on such a design.

FIG. 5 is a diagram schematically showing the relationship between an information charge amount Q and an incident light amount I in the case where the maximum charge handling capacity of the horizontal CCD shift register Q_{HMAX} is less than twice the maximum charge handling capacity of the vertical CCD shift register Q_{VMAX}. In such a case, preferably, the sum of the amount of information charges in an odd line F (I, B) and the amount of information charges in an even line F (I, 2A+B) does not exceed the maximum charge handling capacity of the horizontal CCD shift register Q_{HMAX}. That is, F (I, 2A+B)+F (I, B). Q_{HMAX} is preferable. Here, because an even line F (I, 2A+B) could be saturated with information charges, the relationship F (I, 2A+B). Q_{HMAX} holds. This in turn forces the amount of information charges originated from an even line (F (I, B)) to assume values that will fulfill the expression F (I, B). Q_{HMAX}−Q_{VMAX}. This is taken into consideration in setting of the second exposure signal B. For example, when the amount of compounded information charges G (I_{MAX}, 2A+B) for the maximum incident light amount I_{MAX} is set equal to the maximum handling information charge amount of the horizontal CCD shift register Q_{HMAX}, the maximum charge handling capacity of the horizontal CCD shift register Q_{HMAX} can be best used to improve the dynamic range. FIG. 5 shows such an example, in which the second exposure time is determined so as to hold the relationship F (I_{HMAX}, B)=Q_{HMAX}−Q_{VMAX}.

In the above, information charges originated from an odd line (the (2i−1)^{th} line) are brought to an even line (the 2i^{th} line) to be compounded into those therein in the above description. Alternatively, information charges originated from an even line (the 2i^{th} line) may be brought to an odd line (the (2i+1)^{th} line) to be compounded into those therein.

Further, an arrangement in which information charges originated from an odd line (the (2i−1)^{th} line) may be brought to an even line (the 2i^{th} line) to be compounded to those therein in an odd field, and those originated from an even line (the 2i^{th} line) are brought to an odd line (the (2i+1)th line) to be compounded into those therein in an even field, would enable interlace scanning.

Embodiment 2

An imaging apparatus according to a second preferred embodiment has a structure substantially identical to that shown in the block diagram of FIG. 1, which is referred to in the description for the first preferred embodiment. Thus, FIG. 1 is also referred to in the description of this second embodiment.

The CCD image sensor 2 used in this embodiment may differ from that of the first embodiment in that portions of the vertical CCD shift registers corresponding to an even line and an odd line in the imaging section may not be driven independently. However, the time for accumulating information charges in odd and even lines can be controlled independently.

Several specific structures of such a CCD image sensor 2 may be given. For example, in a CCD image sensor of an interline transfer type having a known structure, reading of information charges from a photodiode to a vertical CCD shift register is conducted by applying a reading voltage to a vertical transfer electrode on the channel between the photodiode and the vertical CCD shift register. With such a structure, only an information charge in a photodiode in an odd line may be read and tentatively accumulated in the vertical CCD shift register midway through the exposure, which is then driven so as to discharge the information charges accumulated therein. With this arrangement, a substantial exposure for the odd line, that is, the second exposure time, can be made shorter than that for an even line, that is, the first exposure time.

In the structure of one known interline transfer type CCD image sensor, a drain is formed beside a photodiode so that overflowing information charges can be discharged. In another known CCD image sensor structure, the channel between the drain and the photodiode is turned on or off using a gate electrode. These structures also enable independent control of information charge accumulating times for odd and even lines.

In the case of a CCD image sensor of a frame transfer type, when the sensor is driven such that a potential well is not formed in portions of vertical shift registers corresponding to each even line, for example, an exposure time for the even line can be made shorter than that for an odd line.

An apparatus device of the present invention using such a CCD image sensor 2 can make a shorter exposure time B for an odd line (the (2i−1)th line) than that for an even line (the 2i^{th} line).

In the following, a case will be described where a CCD image sensor 2 of an interline transfer type is employed. By discharging an information charge accumulated in an odd line midway through an exposure, information charges will have been accumulated to the amount F (I, B) and to the amount F (I, A) in photodiodes in odd and even lines, respectively, by the end of the exposure. These information charges are read from the photodiodes and supplied to the vertical CCD shift register. As a result, information charges of the amount F (I, B) and those of the amount F (I, A) are present in respective adjacent odd and even lines, respectively.

The information charges read and supplied to the vertical CCD shift registers are vertically transferred in a line shift operation with a cycle of one horizontal scanning period. Here, similar to the first embodiment, a line shift operation with a cycle of one horizontal scanning period may involve an operation of vertically transferring an information charge in an even line (the 2i^{th} line) to a horizontal CCD shift register, and that of vertically transferring an information charge in an odd line (the (2i−1)th line) to the horizontal CCD shift register. While information charges for these two lines are being read through vertical transfer to the horizontal CCD shift register, operation of the horizontal CCD shift register remains halted, so that information charges originated from the even line (the 2i^{th} line) and those from the odd line (the (2i−1)^{th} line) are compounded.

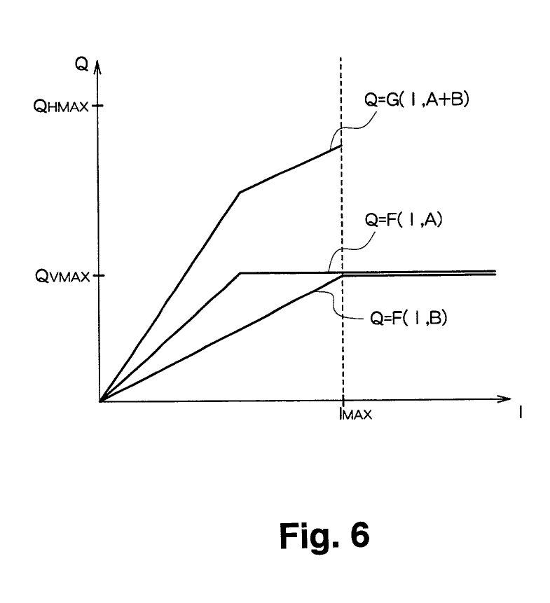

FIG. 6 is a diagram schematically showing the relationship between the amount of information charges Q generated using the driving method and an incident light amount I. The function F (I, A) concerning the amount of information charges generated in an even line (the 2ith line) at the end of the second exposure time takes a large value even in the range of a small amount of incident light I, and reaches a saturation point by a relatively small amount of incident light amount I. The function F (I, B) concerning the amount of information charges generated in an odd line (the (2i−1)th line), on the other hand, does not assume a value as large as that for an even line, and is unlikely to reach a saturation point. The function G (I, A+B) concerning the amount of information charges obtained by compounding these information charges having different characteristics in the horizontal CCD shift register does not form a plateau due to saturation, even in the range of a small amount of incident light I where the function F (I, A) has reached a saturation point. As such, the range of incident light amount wherein the amount of information charges to be generated may vary depending on the amount of incident light is expanded. That is, the dynamic range of an output signal V_{OUT} from the CCD image sensor 2 is widened and improved.

According to a driving method for a solid state imaging device of the present invention, for example, midway through an exposure information charges in an odd line are brought to an adjacent even line, where they are compounded into information charges at the even line, as described in the first embodiment. With this arrangement, information charges are obtained from the even line that have been exposed for a substantially shorter time than those in the odd line, and with such a nature that the likelihood of generation of an amount corresponding to a saturation point is greatly reduced. By combining information charges obtained in an odd line and those in an even line in the horizontal shift register, an output signal can be obtained that exhibits preferable sensitivity for lower luminance, and the likelihood of generation of an amount corresponding to a saturation point under higher luminance is also greatly reduced. That is, the dynamic range of an output signal from a solid state imaging device is advantageously expanded.

What is claimed is:

1. A method for driving a solid state imaging device including a plurality of vertical shift registers each for vertically transferring information charges accumulated in a plurality of light receiving pixels arranged in matrix, and a horizontal shift register for horizontally transferring information charges vertically transferred and received in line units, in which the information charges are independently vertically transferred from light receiving pixels in an odd line and from light receiving pixels in an even line, the method comprising:
an accumulation step of accumulating information charges generated in the plurality of light receiving pixels during a first period in portions of vertical shift registers corresponding to each odd line and in portions of vertical shift registers corresponding to each even line;
a first compounding step of vertically transferring the information charges accumulated in the portions of vertical shift registers corresponding to each odd line to the portions of vertical shift registers corresponding to each adjacent even line, compounding the information charges originated from the portions of vertical shift registers corresponding to each odd line into the information charges accumulated in the portions of vertical shift registers corresponding to each adjacent even line, and holding resultant information charges in the portions of vertical shift registers corresponding to each even line;
an additional accumulation step of accumulating information charges generated in a light receiving pixel in each odd line during a second period in the portions of vertical shift registers corresponding to each odd line, and of accumulating information charges generated in a light receiving pixel in each even line during the second period in the portions of vertical shift registers corresponding to each even line in addition to the information charges that are already accumulated therein;
a second compounding step of transferring the information charges accumulated in the portions of vertical shift registers corresponding to each odd line and the information charges accumulated in the portions of vertical shift registers corresponding to each even line to the horizontal shift register, and compounding in the horizontal shift register the information charges originated from the portions of vertical shift registers corresponding to each odd line into the information charges originated from the portions of vertical shift registers corresponding to each even line; and
a step of driving the horizontal shift register after the second compounding step to obtain an information output of the solid state imaging device.

2. A driving method according to claim 1, wherein
the second period is determined such that the amount of information charges generated in each of the plurality of light receiving pixels during the second period is equal to or less than the charge storage capacity of the light receiving pixels.

3. A driving method according to claim 1, wherein
the second period is determined such that the amount of information charges generated in a light receiving pixel corresponding to a maximum luminance portion of an object during the second period falls within a predetermined range relative to the charge storage capacity of the light receiving pixel.

4. A method for driving a solid state imaging device including a plurality of vertical shift registers each for vertically transferring information charges accumulated in a plurality of light receiving pixels arranged in matrix, and a horizontal shift register for horizontally transferring information charges vertically transferred and received in line units of line, in which the information charges are independently vertically transferred from light receiving pixels in an odd line and from light receiving pixels in an even line, the method comprising:
an imaging step of accumulating during a first period the information charges generated in the light receiving pixels in each odd line and of accumulating during a second period the information charges generated in the light receiving pixels in each even line, the second period being shorter than the first period; and
a compounding step of vertically transferring the information charges accumulated in the light receiving pixels in each odd line and the information charged accumulated in the light receiving pixels in each even line to the horizontal shift register after the imaging step, and of compounding the information charges originating from the light receiving pixels in each odd line with the information charges originating from the light receiving pixels in each even line;
a step of driving the horizontal shift register after the compounding step to obtain an information output of the solid state imaging device.

5. A driving method according to claim 4, wherein
the second period is determined such that the amount of information charges generated in each of the plurality of light receiving pixels during the second period is equal to or less than the charge storage capacity of the light receiving pixels.

6. A driving method according to claim 4, wherein
the second period is determined such that the amount of information charges generated in a light receiving pixel corresponding to a maximum luminance portion of an object during the second period falls within a predetermined range relative to the charge storage capacity of the light receiving pixel.
